(19) United States
(12) Patent Application Publication
(10) Pub. No.: US 2026/0342112 A1
(43) Pub. Date: Oct. 29, 2026

(54) BATTERY PROTECTION CIRCUIT

(71) Applicant: Zgmicro Wuxi Corporation, Wuxi (CN)

(72) Inventor: Hang YIN, Wuxi (CN)

(21) Appl. No.: 19/657,433

(22) Filed: Apr. 24, 2026

(30) Foreign Application Priority Data
Apr. 25, 2025 (CN) 202510528531.6
Jun. 6, 2025 (CN) 202510752406.3

(51) Int. Cl. H02J 7/60; H02J 7/00

(52) U.S. Cl. CPC H02J 7/685; H02J 7/855; H02J 7/865

(57) ABSTRACT

The present invention provides a battery protection circuit which comprises: a first charging port, a first discharging port, a second charging port, a second discharging port, a charge-discharge switch assembly, a battery protection unit, a battery, a shunt switch, and a control circuit. The shunt switch is coupled between the battery and the second charging port, and the control circuit is configured to control the charging port to be conductive only when the charger is coupled; and/or the shunt switch is coupled between the battery and the second discharging port, and the control circuit is configured to control the discharging port to be conductive only when the load is coupled. The present invention can improve effect of separate control of a charging loop and a discharging loop.

### CROSS-REFERENCE OF RELATED APPLICATIONS

The present invention claims priorities of Chinese Patent Application No. 2025105285316 filed in China on Apr. 25, 2025, and Chinese Patent Application No. 2025107524063 filed in China on Jun. 6, 2025, the entire contents of which are incorporated herein by reference.

### BACKGROUND OF THE INVENTION

### Field of the Invention

The present invention relates to the technical field of battery protection, and more particularly, to a battery protection circuit.

### Description of the Related Art

Currently, some batteries require separation of a charging port and a discharging port of a battery protection circuit.

It has been found in practice that although the charging port and the discharging port of the battery protection circuit are arranged separately, a discharging load can still be coupled to the charging port and operate, and a charger can also be coupled to the discharging port and operate.

That is, a battery protection circuit designed in the prior art has a poor effect of separate control of a charging loop and a discharging loop.

### SUMMARY OF THE INVENTION

An objective of the present invention is to provide a battery protection circuit, so as to solve the technical problem of a poor effect of separate control of a charging loop and a discharging loop in a battery protection circuit designed in the prior art.

According to one aspect of the present invention, a battery protection circuit is provided. The battery protection circuit comprises: a first charging port, a first discharging port, a second charging port, a second discharging port, a charge-discharge switch assembly, a battery protection unit, a battery, a shunt switch, and a control circuit electrically coupled to a control terminal of the shunt switch; wherein the first charging port, the battery, the charge-discharge switch assembly, and the second charging port form a charging loop, and the first discharging port, the battery, the charge-discharge switch assembly, and the second discharging port form a discharging loop; wherein when the shunt switch is electrically coupled between the charge-discharge switch assembly and the second charging port, the control circuit is configured to: detect whether a device electrically coupled between the first charging port and the second charging port is a charger or a load, control the shunt switch to turn on when the charger is electrically coupled between the first charging port and the second charging port, and control the shunt switch to turn off when the load is electrically coupled between the first charging port and the second charging port; wherein when the shunt switch is electrically coupled between the charge-discharge switch assembly and the second discharging port, the control circuit is configured to: detect whether a device electrically coupled between the first discharging port and the second discharging port is a charger or a load, and control the shunt switch to turn off when the charger is electrically coupled between the first discharging port and the second discharging port, and control the shunt switch to turn on when the load is electrically coupled between the first discharging port and the second discharging port.

According to another aspect of the present invention, a battery protection circuit is provided. The battery protection circuit comprises: a first charging port, a first discharging port, a second charging port, a second discharging port, a charge-discharge switch assembly, a battery protection unit, a battery, a shunt switch, and a control circuit electrically coupled to a control terminal of the shunt switch; wherein the first charging port, the battery, the charge-discharge switch assembly, and the second charging port form a charging loop, and the first discharging port, the battery, the charge-discharge switch assembly, and the second discharging port form a discharging loop; wherein when the shunt switch is electrically coupled within the charging loop, the control circuit is configured to: detect whether a device electrically coupled between the first charging port and the second charging port is a charger or a load, control the shunt switch to turn on when the charger is electrically coupled between the first charging port and the second charging port, and control the shunt switch to turn off when the load is electrically coupled between the first charging port and the second charging port; wherein when the shunt switch is electrically coupled within the discharging loop, the control circuit is configured to: detect whether a device electrically coupled between the first discharging port and the second discharging port is the charger or the load, and control the shunt switch to turn off when the charger is electrically coupled between the first discharging port and the second discharging port, and control the shunt switch to turn on when the load is electrically coupled between the first discharging port and the second discharging port.

In the present invention, the shunt switch and the control circuit coupled to a control terminal of the shunt switch are utilized to detect whether a device coupled through two charging ports is a charger or a load. If the device is a charger, the shunt switch is controlled to turn on. If the device is a load, the shunt switch is controlled to turn off.

Additionally or alternatively, the shunt switch and the control circuit coupled to a control terminal of the shunt switch are utilized to detect whether a device coupled through two discharging ports is a charger or a load. If the device is a charger, the shunt switch is controlled to turn off. if the device is a load, the shunt switch is controlled to turn on.

In this way, the charging port of the battery protection circuit is restricted to be used only for charging, and/or the discharging port of the battery protection circuit is restricted to be used only for discharging. This can improve the effect of separate control of the charging loop and the discharging loop in the battery protection circuit, thereby better meeting requirement of separating the charging port and the discharging port of the battery protection circuit, avoiding risks caused by incorrect use of the charging and discharging ports, and enhancing safety of corresponding electronic devices.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 is a schematic structural diagram of a battery protection circuit according to one embodiment of the present invention;

FIG. 2 is a schematic diagram of a battery protection circuit satisfying a charging port restriction according to one embodiment of the present invention;

FIG. 3 is a schematic diagram of a battery protection circuit satisfying a discharging port restriction according to one embodiment of the present invention;

FIG. 4 is a schematic diagram of a battery protection circuit satisfying both a charging port restriction and a discharging port restriction according to one embodiment of the present invention;

FIG. 5 is a schematic diagram of a first implementation example of an operational amplifier circuit according to one embodiment of the present invention;

FIG. 6 is a schematic diagram of a second implementation example of the operational amplifier circuit according to one embodiment of the present invention;

FIG. 7 is a schematic diagram of a third implementation example of the operational amplifier circuit according to one embodiment of the present invention;

FIG. 8 is a schematic diagram of another battery protection circuit satisfying a charging port restriction according to one embodiment of the present invention;

FIG. 9 is a schematic diagram of another battery protection circuit satisfying a discharging port restriction according to one embodiment of the present invention;

FIG. 10 is a schematic diagram of another battery protection circuit satisfying both a charging port restriction and a discharging port restriction according to one embodiment of the present invention;

FIG. 11 is a schematic diagram of a fourth implementation example of the operational amplifier circuit according to one embodiment of the present invention;

FIG. 12 is a schematic diagram of a fifth implementation example of the operational amplifier circuit according to one embodiment of the present invention;

FIG. 13 is a schematic diagram of a sixth implementation example of the operational amplifier circuit according to one embodiment of the present invention;

FIG. 14 is a schematic diagram of still another battery protection circuit satisfying a charging port restriction according to one embodiment of the present invention;

FIG. 15 is a schematic diagram of yet another battery protection circuit satisfying a charging port restriction according to one embodiment of the present invention;

FIG. 16 is a schematic diagram of still another battery protection circuit satisfying a discharging port restriction according to one embodiment of the present invention; and

FIG. 17 is a schematic diagram of yet another battery protection circuit satisfying a discharging port restriction according to one embodiment of the present invention.

### DETAILED DESCRIPTION OF THE PREFERRED

### Embodiments

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The technical solutions in the embodiments of the present disclosure will be clearly and completely described below with reference to the accompanying drawings in the embodiments of the present disclosure. Apparently, the described embodiments are merely some, rather than all, of the embodiments of the present disclosure. All other embodiments obtained by those of ordinary skill in the art based on the embodiments of the present disclosure without making creative efforts shall fall within the protection scope of the present disclosure.

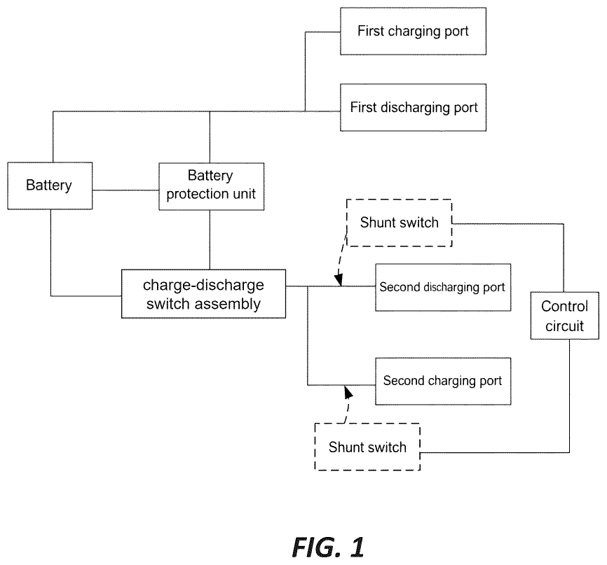

The present invention provides a battery protection circuit. As shown in FIG. 1, the battery protection circuit comprises: a first charging port, a first discharging port, a second charging port, a second discharging port, a charge-discharge switch assembly, a battery protection unit, a battery, a shunt switch, and a control circuit electrically coupled to a control terminal of the shunt switch.

The first charging port, the battery, the charge-discharge switch assembly, and the second charging port form a charging loop, and the first discharging port, the battery, the charge-discharge switch assembly, and the second discharging port form a discharging loop.

When the shunt switch is electrically coupled between the charge-discharge switch assembly and the second charging port, the control circuit is configured to: detect whether a device electrically coupled between the first charging port and the second charging port is a charger or a load, and control the shunt switch to turn on (so that the charging loop is in a closed state) when the charger is electrically coupled between the first charging port and the second charging port, and control the shunt switch to turn off (so that the charging loop is in an open state) when the load is electrically coupled between the first charging port and the second charging port;

When the shunt switch is electrically coupled between the charge-discharge switch assembly and the second discharging port, the control circuit is configured to: detect whether a device electrically coupled between the first discharging port and the second discharging port is a charger or a load, and control the shunt switch to turn off when the charger is electrically coupled between the first discharging port and the second discharging port (so that the discharging loop is in an open state), and control the shunt switch to turn on when the load is electrically coupled between the first discharging port and the second discharging port (so that the discharging loop is in a closed state).

In the present invention, the shunt switch and the control circuit coupled to the control terminal of the shunt switch are utilized to detect whether a device coupled through two charging ports is a charger or a load. If the device is a charger, the shunt switch is controlled to turn on; if the device is a load, the shunt switch is controlled to turn off. Additionally or alternatively, the shunt switch and the control circuit coupled to the control terminal of the shunt switch are utilized to detect whether a device coupled through two discharging ports is a charger or a load. If the device is a charger, the shunt switch is controlled to turn off; if the device is a load, the shunt switch is controlled to turn on. In this way, the charging port of the battery protection circuit is restricted to be used only for charging, and/or the discharging port of the battery protection circuit is restricted to be used only for discharging. This can improve the effect of separate control of the charging loop and the discharging loop in the battery protection circuit, thereby better meeting the requirement of separating the charging port and the discharging port of the battery protection circuit, avoiding risks caused by incorrect use of the charging and discharging ports, and enhancing the safety of corresponding electronic devices.

It should be noted that the example of FIG. 1 only illustrates a situation where the shunt switch is arranged at the second discharging port or the second charging port. However, in practical applications, the shunt switch may also be arranged at the first discharging port or the first charging port.

In other words, the shunt switch can electrically coupled within the charging loop or the discharging loop When the shunt switch is electrically coupled within the charging loop, the control circuit is configured to detect whether a device electrically coupled between the first charging port and the second charging port is a charger or a load, control the shunt switch to turn on when the charger is electrically coupled between the first charging port and the second charging port, and control the shunt switch to turn off when the load is electrically coupled between the first charging port and the second charging port. When the shunt switch is electrically coupled within the discharging loop, the control circuit is configured to detect whether a device electrically coupled between the first discharging port and the second discharging port is a charger or a load, and control the shunt switch to turn off when the charger is electrically coupled between the first discharging port and the second discharging port, and control the shunt switch to turn on when the load is electrically coupled between the first discharging port and the second discharging port.

In one embodiment, the first charging port and the first discharging port are a shared first charge-discharge port, and the second charging port and the second discharging port are two mutually independent ports.

In this embodiment, one charging port and one discharging port are configured as a shared port, so as to simplify structural arrangement of the battery protection circuit while ensuring normal operation of the discharging loop and the charging loop.

In one embodiment, the first charging port is a C+ charging port, the second charging port is a C− charging port, the first discharging port is a P+ discharging port, and the second discharging port is a P− discharging port; or, the first charging port is a C− charging port, the second charging port is a C+ charging port, the first discharging port is a P− discharging port, and the second discharging port is a P+ discharging port.

In this embodiment, based on the above configuration, the arrangement of the charging ports and the discharging ports is made more flexible, so as to dynamically adapt to varied port arrangement requirements in practical applications.

Further, the charge-discharge switch assembly comprises a charging switch and a discharging switch coupled in series, and an output terminal of the battery protection unit comprises a first control output terminal and a second control output terminal. The first control output terminal of the battery protection unit is coupled to a control terminal of the charging switch, and the second control output terminal of the battery protection unit is coupled to a control terminal of the discharging switch.

In this embodiment, based on provision of the charging switch and the discharging switch, the battery protection unit has capability of controlling the discharging loop and the charging loop, thereby supporting corresponding turn-off or turn-on control of the discharging loop and the charging loop, thus further enhancing the applicability of the battery protection circuit of the present invention.

In one embodiment, the first charging port, the first discharging port, and a first power supply terminal of the battery protection unit are all electrically coupled to a positive electrode or a negative electrode of the battery; a second power supply terminal of the battery protection unit and a first conductive connection terminal of the charge-discharge switch assembly are both electrically coupled to the negative electrode or the positive electrode of the battery; an output terminal of the battery protection unit is electrically coupled to a control terminal of the charge-discharge switch assembly; and the second charging port and the second discharging port are both electrically coupled to a second conductive connection terminal of the charge-discharge switch assembly.

The shunt switch is a MOS transistor, one conductive connection terminal of the MOS transistor is electrically coupled to the charge-discharge switch assembly, the other conductive connection terminal of the MOS transistor is electrically coupled to the second charging port or the second discharging port, and a gate of the MOS transistor is electrically coupled to an output terminal of the control circuit.

By utilizing low on-resistance characteristic of the MOS transistor, a voltage drop across the shunt switch when current flows therethrough is reduced as much as possible, so that a charging voltage and/or a discharging voltage of the battery can be maintained at a relatively high level, thereby improving charging efficiency and/or discharging efficiency of the battery. In battery protection applications requiring separation of charging and discharging ports, a unidirectional conduction current path with a conduction voltage drop lower than that of a diode can be achieved, whereby charge-discharge efficiency can be improved, the voltage drop can be reduced, and a selection range for a charger voltage can be broadened.

In one embodiment, the control circuit comprises an operational amplifier, and an output terminal of the operational amplifier is electrically coupled to the control terminal of the shunt switch. A first connection terminal of the operational amplifier is electrically coupled to the second charging port, and a second connection terminal of the operational amplifier is electrically coupled to a first internal node, the first internal node being a node between the second discharging port and the negative electrode of the battery; or, the first connection terminal of the operational amplifier is electrically coupled to the second discharging port, and the second connection terminal of the operational amplifier is electrically coupled to a second internal node, the second internal node being a node between the second charging port and the negative electrode of the battery.

Based on the above configuration, turn-on/turn-off control of the MOS transistor is accomplished conveniently and at low cost. The arrangement of the first internal node and the second internal node enables the connection of the second connection terminal of the operational amplifier to be more flexible, thereby making the application of the battery protection circuit of the present invention more flexible as well.

Further, the operational amplifier is configured to: amplify a difference between a voltage at the first connection terminal and a voltage received at the second connection terminal, and output an amplified difference to the control terminal of the shunt switch.

Specifically, when the first connection terminal of the operational amplifier is electrically coupled to the second charging port, and the second connection terminal of the operational amplifier is electrically coupled to the first internal node, the first internal node being the node between the second discharging port and the negative electrode of the battery.

If a charger is coupled between the first charging port and the second charging port, the first connection terminal will be coupled to the negative electrode of the charger. At the initial moment of connection, the voltage at the first connection terminal is pulled down, and the voltage difference between the first connection terminal and the second connection terminal tends to increase, causing an output signal at the output terminal of the operational amplifier to be further amplified, i.e., the signal received at the gate of the shunt switch tends to increase. The drain and source of the shunt switch tend to turn on, the voltage drop across the shunt switch decreases, the voltage at the first connection terminal will be pulled up, and the voltage difference between the first connection terminal and the second connection terminal tends to decrease, causing the output signal at the output terminal of the operational amplifier to tend to decrease. The conduction degree between the drain and source of the shunt switch decreases, the voltage drop across the shunt switch increases, and the voltage at the first connection terminal is pulled down again. This cycle repeats to form a negative feedback loop, and a stable path can be formed between the drain and source of the shunt switch. By appropriately adjusting the gain and input offset of the shunt switch, the voltage drop caused by the shunt switch can be controlled within an expected range, so as to ensure that the charger can stably charge the battery.

If a load is coupled between the first charging port and the second charging port, the first connection terminal is essentially coupled to the positive electrode of the battery. At the initial moment of connection, the voltage at the first connection terminal is pulled up, and the voltage difference between the first connection terminal and the second connection terminal tends to decrease, causing the voltage of the output signal at the output terminal of the operational amplifier to drop, i.e., the signal received at the gate of the shunt switch tends to decrease. The drain and source of the shunt switch tend to be turned off, the voltage at the first connection terminal will be further pulled up, and the voltage difference between the first connection terminal and the second connection terminal further decreases, thus forming a positive feedback loop, and the shunt switch is stably cut off between its drain and source. By appropriately adjusting the gain and input offset of the shunt switch, zero tolerance or limited tolerance for load current can be achieved.

The feedback loops when a charger or a load is coupled between the first discharging port and the second discharging port are similar. The difference lies in that when a load is coupled between the first discharging port and the second discharging port, a stable path can be formed between the drain and source of the shunt switch; and when a charger is coupled between the first discharging port and the second discharging port, the shunt switch is stably cut off between its drain and source.

In one embodiment, the operational amplifier comprises: a first bipolar transistor, a second bipolar transistor, and a third bipolar transistor.

A base of the first bipolar transistor and a base of the second bipolar transistor are both electrically coupled to an emitter of the third bipolar transistor; a collector of the first bipolar transistor is electrically coupled to the emitter of the third bipolar transistor; a collector of the third bipolar transistor is electrically coupled to an emitter of the first bipolar transistor; a collector of the second bipolar transistor is electrically coupled to the emitter of the third bipolar transistor; and a base of the third bipolar transistor is electrically coupled to the collector of the second bipolar transistor.

The first connection terminal is a terminal at the emitter of the first bipolar transistor, the second connection terminal is a terminal at an emitter of the second bipolar transistor, and the output terminal of the operational amplifier is a terminal at the collector of the third bipolar transistor.

In this embodiment, based on the above configuration, reliable operational amplification control is achieved through three cooperating transistors, which can reduce the implementation cost of the operational amplifier.

It should be noted that in applications, the first bipolar transistor and the second bipolar transistor can be respectively replaced with corresponding MOS transistors, and the third bipolar transistor can also be replaced with a corresponding MOS transistor, so as to reduce the voltage drop and heat generation of the operational amplifier. For a bipolar transistor and a MOS transistor that are mutually replaceable, the base of the bipolar transistor corresponds to a gate of the MOS transistor, the collector of the bipolar transistor corresponds to a drain of the MOS transistor, and the emitter of the bipolar transistor corresponds to a source of the MOS transistor.

In one embodiment, a first resistor is coupled in series between the base of the first bipolar transistor and the emitter of the third bipolar transistor; a second resistor is coupled in series between the base of the third transistor and the emitter of the third bipolar transistor; and a third resistor is coupled in series between the collector of the second bipolar transistor and the base of the third bipolar transistor, a fourth resistor is coupled in series between the collector of the third bipolar transistor and the emitter of the first bipolar transistor.

In this embodiment, based on the cooperative arrangement of the first resistor, the second resistor, and the third resistor, adaptive adjustment of an input offset of the corresponding shunt switch is achieved, making the application of the battery protection circuit of the present invention more flexible.

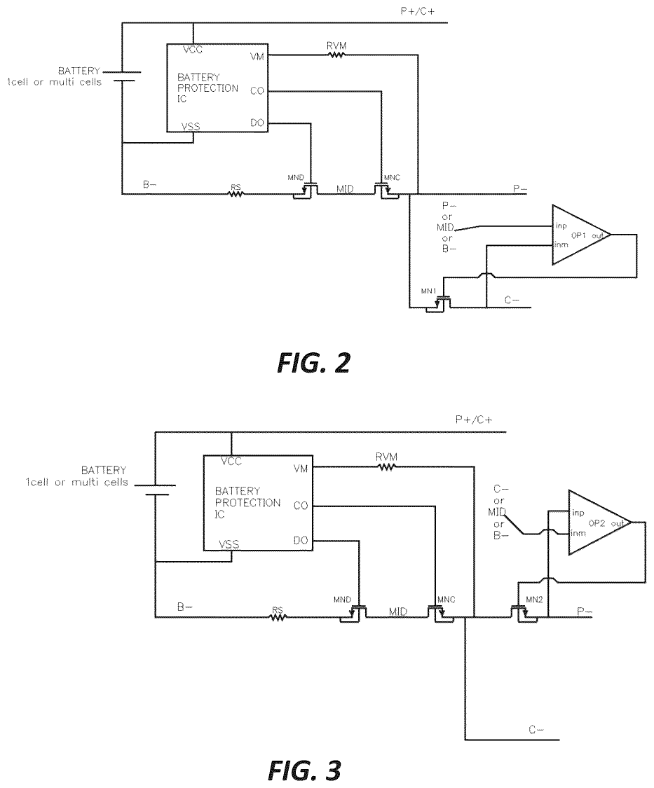

By way of example, when the protection circuit separates the charging port and the discharging port, and satisfies the requirement that the charging port can only be used for charging and cannot be used for discharging, the corresponding protection circuit may be as shown in FIG. 2.

In FIG. 2, BATTERY can be understood as the aforementioned battery, BATTERY PROTECTION IC can be understood as the aforementioned battery protection unit, P+ terminal can be understood as the aforementioned P+discharging port, P− terminal can be understood as the aforementioned P− discharging port, C+ terminal can be understood as the aforementioned C+ charging port, and C− terminal can be understood as the aforementioned C− charging port. In this example, the first charging port is the C+ charging port, the second charging port is the C− charging port, the first discharging port is the P+ discharging port, and the second discharging port is the P− discharging port. Alternatively, the first charging port is the C− charging port, the second charging port is the C+ charging port, the first discharging port is the P− discharging port, and the second discharging port is the P+ discharging port. However, it should be noted that since the P+ terminal and the C+ terminal are a shared port in this example, the P+ terminal and the C+ terminal are represented as a P+/C+ terminal in FIG. 2.

A VCC terminal can be understood as the aforementioned first power supply terminal of the battery protection unit, and a VSS terminal can be understood as the aforementioned second power supply terminal of the battery protection unit.

RS and RVM are resistors. VM, CO, and DO are different functional ports of the chip, wherein the VM port can be used to monitor the voltage at the P− terminal, the CO port is a charging control output terminal for controlling battery charging, and the DO port is a discharging control output terminal for controlling battery discharging. The CO port can be understood as the aforementioned first control output terminal of the battery protection unit, and the DO port can be understood as the aforementioned second control output terminal of the battery protection unit.

MND can be understood as the aforementioned discharging switch, i.e., an NMOS transistor for turning on or off the discharging loop of the battery according to a control signal from the DO port. MNC can be understood as the aforementioned charging switch, i.e., an NMOS transistor for turning on or off the charging loop of the battery according to a control signal from the CO port. A composite structure formed by connecting MND and MNC in series can be understood as the aforementioned charge-discharge switch assembly. The P+ terminal, the P− terminal, the BATTERY, MND, and MNC form the discharging loop, and the C+ terminal, the C− terminal, the BATTERY, MND, and MNC form the charging loop.

In the charging loop, an NMOS transistor MN1 (which can be understood as the shunt switch electrically coupled between the charge-discharge switch assembly and the second charging port) is added at the C− terminal. The drain of MN1 is coupled to C−, the bulk and source of MN1 are coupled to P−, and the gate of MN1 is driven by the output of an operational amplifier circuit OP1 (which can be understood as the aforementioned control circuit, and more specifically, the aforementioned operational amplifier).

For the operational amplifier circuit OP1, inp is a positive input terminal, inm is a negative input terminal, and the output out outputs an amplified voltage signal. The inp terminal (which can be understood as the second connection terminal of the aforementioned operational amplifier) of OP1 can optionally be coupled to P−, or MID, or B−, or any node on the current path from P− to B− (which can be understood as the aforementioned first internal node), and the inm terminal (which can be understood as the first connection terminal of the aforementioned operational amplifier) is coupled to the C− potential.

When a charger is coupled to the C+/C− ports, the voltage at the inm terminal of OP1 is pulled down, the voltage difference between inp and inm rises, the output voltage out of the operational amplifier circuit rises, driving MN1 to tend to turn on and pulling up the C− potential (i.e., the inm potential). At this time, a negative feedback control loop is formed, so that the Vds voltage drop across MN1 during charging is controllable. By appropriately adjusting the gain and input offset of OP1, adjustment of the Vds of MN1 during charging can be achieved.

When a load is coupled to the C+/C− ports, the voltage at the inm terminal of OP1 is pulled up, the voltage difference between inp and inm drops, the output voltage out of the operational amplifier circuit drops, driving MN1 to tend to be turned off, thereby making it easier for the load to pull up C− (i.e., the inm potential). At this time, a positive feedback control loop is formed, so that when a load is coupled to C+/C−, MN1 can be stably in an off state that prohibits discharging. Similarly, by appropriately adjusting the gain and input offset of OP1, the tolerance of C+/C− for load current, such as zero tolerance or limited tolerance, can be achieved.

It should be noted that FIG. 2 only illustrates the situation where the operational amplifier circuit OP1 and the NMOS transistor MN1 are arranged at the C− terminal. In practical applications, after changing the type of the NMOS transistor MN1 to a PMOS transistor, the operational amplifier circuit OP1 and the PMOS transistor MN1 can also be arranged at the C+ terminal.

When the battery protection circuit separates the charging port and the discharging port, and satisfies the requirement that the discharging port can only be used for discharging and cannot be used for charging, the corresponding protection circuit may be as shown in FIG. 3.

The meanings of the relevant elements in FIG. 3 can be found in the corresponding description of the example in FIG. 2. The difference lies in that in the discharging loop, an NMOS transistor MN2 (which can be understood as the shunt switch electrically coupled between the charge-discharge switch assembly and the second discharging port) is added at the P− terminal. The drain of MN2 is coupled to C−, the bulk and source of MN2 are coupled to P−, and the gate of MN2 is driven by the output of an operational amplifier circuit OP2.

For the operational amplifier circuit OP2 (which can be understood as the aforementioned control circuit, and more specifically, the aforementioned operational amplifier), inp is a positive input terminal for a differential signal, inm is a negative input terminal for the differential signal, and the operational amplifier circuit OP2 outputs an amplified voltage signal of the differential signal. The inp terminal (which can be understood as the first connection terminal of the aforementioned operational amplifier) of OP2 is coupled to the P− potential, and the inm terminal (which can be understood as the second connection terminal of the aforementioned operational amplifier) can optionally be coupled to C−, or MID, or B−, or any node on the current path from C− to B− (which can be understood as the aforementioned second internal node).

When a load is coupled to the P+/P− ports, the voltage at the inp terminal of OP2 is pulled up, the voltage difference between inp and inm rises, the output voltage out of the operational amplifier circuit rises, driving MN2 to tend to turn on and pulling down the P− potential (i.e., the inp potential). At this time, a negative feedback control loop is formed, so that the Vds voltage drop across MN2 during discharging is controllable. By appropriately adjusting the gain and input offset of OP2, adjustment of the Vds of MN2 during discharging can be achieved.

When a charger is coupled to the P+/P− ports, the voltage at the inp terminal of OP2 is pulled down, the voltage difference between inp and inm drops, the output voltage out of the operational amplifier circuit drops, driving MN2 to tend to be turned off, thereby making it easier for the charger to pull down P− (i.e., the inp potential). At this time, a positive feedback control loop is formed, so that when a charger is coupled to P+/P−, MN2 can be stably in an off state that prohibits charging. Similarly, by appropriately adjusting the gain and input offset of OP2, the tolerance of P+/P− to the charging current, such as zero tolerance or limited tolerance, can be realized.

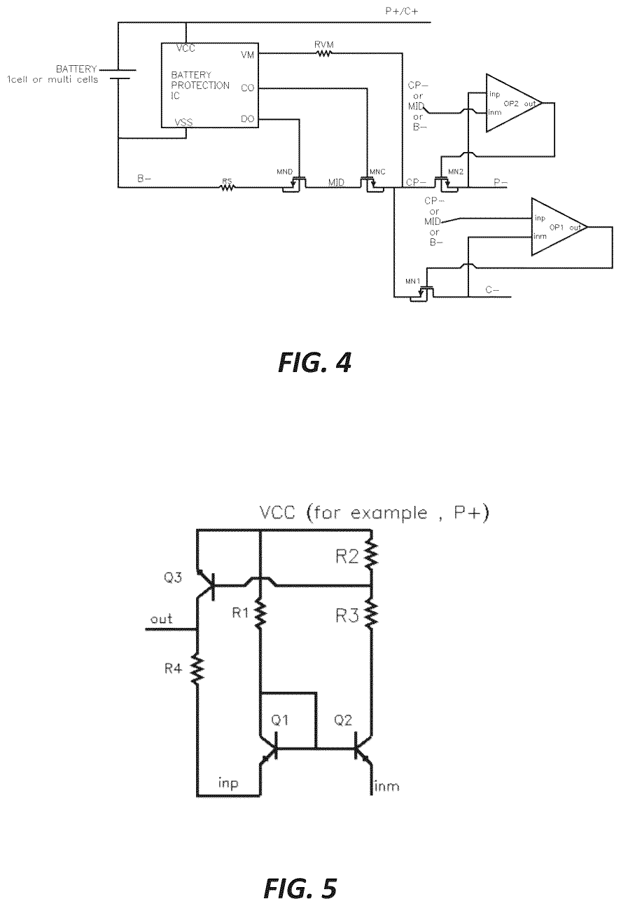

When the protection circuit separates the charging port and the discharging port, and satisfies the requirements that the charging port can only be used for charging and cannot be used for discharging, and the discharging port can only be used for discharging and cannot be used for charging, the corresponding protection circuit may be as shown in FIG. 4.

It should be noted that FIG. 3 only illustrates the situation where the operational amplifier circuit OP2 and the NMOS transistor MN2 are arranged at the P− terminal. In practical applications, after changing the type of the NMOS transistor MN2 to a PMOS transistor, the operational amplifier circuit OP2 and the PMOS transistor MN2 can also be arranged at the P+ terminal.

The meanings of the relevant elements in FIG. 4 can be found in the corresponding descriptions of the examples in FIG. 2 and FIG. 3. FIG. 4 can be regarded as a combination of the solutions of FIG. 2 and FIG. 3. Specifically: since the P+ terminal and the C+ terminal are a shared port, the P+ terminal and the C+ terminal are represented as a P+/C+ terminal in FIG. 2.

An NMOS transistor MN1 is added at the C− terminal, with its drain coupled to C−, its bulk and source coupled to CP−, and its gate driven by the output of the operational amplifier circuit OP1.

For the operational amplifier circuit OP1, inp is a positive input terminal for a differential signal, inm is a negative input terminal for the differential signal, and the output outputs an amplified voltage signal of the differential signal. The inp terminal of OP1 can optionally be coupled to CP−, or MID, or B−, or any node on the current path from CP− to B−, and the inm terminal is coupled to the C− potential.

When a charger is coupled to the C+/C− ports, the voltage at the inm terminal of OP1 is pulled down, the voltage difference between inp and inm rises, the output voltage out of the operational amplifier circuit rises, driving MN1 to tend to turn on and pulling up the C− potential (i.e., the inm potential). At this time, a negative feedback control loop is formed, so that the Vds voltage drop across MN1 during charging is controllable. By appropriately adjusting the gain and input offset of OP1, adjustment of the Vds of MN1 during charging can be achieved.

When a load is coupled to the C+/C− ports, the voltage at the inm terminal of OP1 is pulled up, the voltage difference between inp and inm drops, the output voltage out of the operational amplifier circuit drops, driving MN1 to tend to be turned off, thereby making it easier for the load to pull up C− (i.e., the inm potential). At this time, a positive feedback control loop is formed, so that when a load is coupled to C+/C−, MN1 can be stably in an off state that prohibits discharging. Similarly, by appropriately adjusting the gain and input offset of OP1, the tolerance of C+/C− for load current can be achieved, such as zero tolerance or limited tolerance.

An NMOS transistor MN2 is added at the P− terminal, with its drain coupled to CP−, its bulk and source coupled to P−, and its gate driven by the output of an operational amplifier circuit OP2.

For the operational amplifier circuit OP2, inp is a positive input terminal for a differential signal, inm is a negative input terminal for the differential signal, and the output out outputs an amplified voltage signal of the differential signal. The inp terminal of OP2 is coupled to the P− potential, and the inm terminal can optionally be coupled to CP−, or MID, or B−, or any node on the current path from CP− to B−.

When a load is coupled to the P+/P− ports, the voltage at the inp terminal of OP2 is pulled up, the voltage difference between inp and inm rises, the output voltage out of the operational amplifier circuit rises, driving MN1 to tend to turn on and pulling down the P− potential (i.e., the inp potential). At this time, a negative feedback control loop is formed, so that the Vds voltage drop across MN1 during discharging is controllable. By appropriately adjusting the gain and input offset of OP2, adjustment of the Vds of MN1 during discharging can be achieved.

When a charger is coupled to the P+/P− ports, the voltage at the inp terminal of OP2 is pulled down, the voltage difference between inp and inm drops, the output voltage out of the operational amplifier circuit drops, driving MN1 to tend to be turned off, thereby making it easier for the charger to pull down P− (i.e., the inp potential). At this time, a positive feedback control loop is formed, so that when a charger is coupled to P+/P−, MN1 can be stably in an off state that prohibits charging. Similarly, by appropriately adjusting the gain and input offset of OP2, the tolerance of P+/P− for charging current can be achieved, such as zero tolerance or limited tolerance.

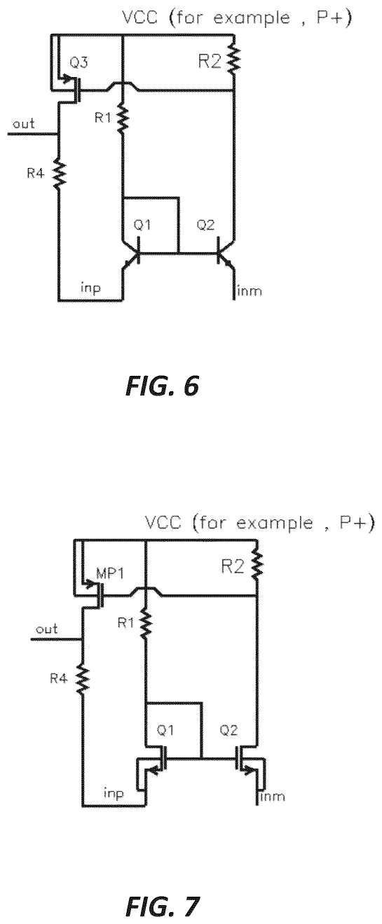

In the present invention, specific implementation methods of the operational amplifier circuits OP1 and OP2 can be seen in FIG. 5 to FIG. 7.

In FIG. 5 to FIG. 7, Q1 (which can be understood as the aforementioned first bipolar transistor) and Q2 (which can be understood as the aforementioned second bipolar transistor) are npn bipolar transistors or NMOS transistors, Q3 (which can be understood as the aforementioned third bipolar transistor) is a pnp bipolar transistor or a PMOS transistor, and R1 (which can be understood as the aforementioned first resistor), R2 (which can be understood as the aforementioned second resistor), R3 (which can be understood as the aforementioned third resistor), and R4 (which can be understood as the aforementioned fourth resistor) are resistors.

Wherein, R3 functions for current limiting and voltage division, and may be omitted if Q3 has sufficient voltage withstand capability or current carrying capacity.

The size ratio or transistor type of Q1 and Q2 can be appropriately adjusted to achieve different input offsets. Transistors or resistors may also be coupled in series between the emitters or sources of Q1, Q2 and inp, inm to achieve different input offsets.

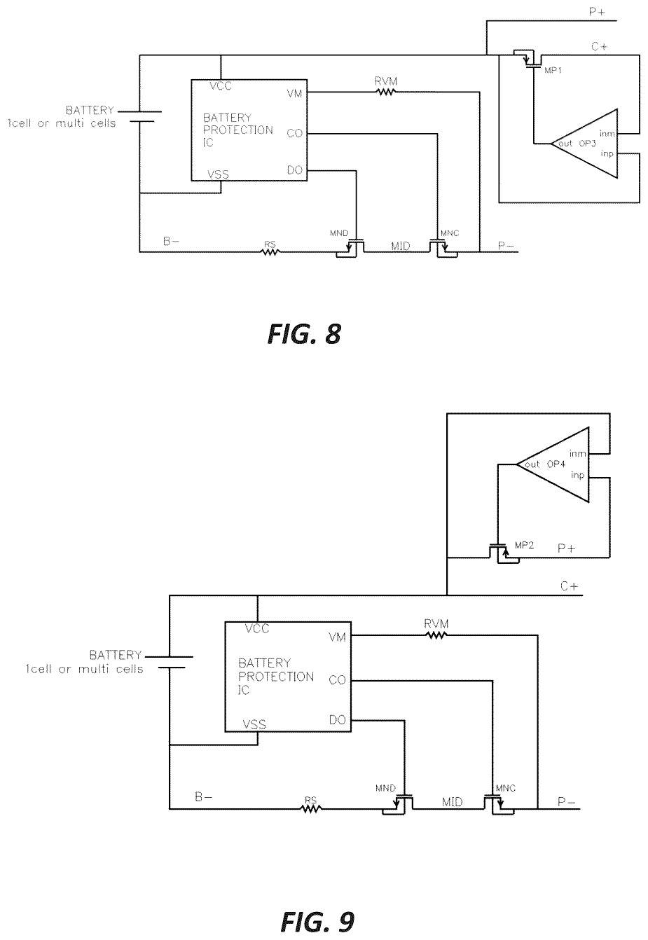

When the protection circuit separates the charging port and the discharging port, and the charging positive terminal and the discharging positive terminal are independent of each other, while satisfying the requirement that the charging port can only be used for charging and cannot be used for discharging, the corresponding protection circuit may be as shown in FIG. 8.

A PMOS transistor MP1 is added at the C+ terminal, with its drain coupled to C+, its bulk and source coupled to P+, and its gate driven by the output of an operational amplifier circuit OP3 (having the same function as the aforementioned operational amplifier circuit OP1).

For the operational amplifier circuit OP3, inp is a positive input terminal for a differential signal, inm is a negative input terminal for the differential signal, and the output out outputs an amplified voltage signal of the differential signal. The inp terminal of OP3 is coupled to P+, and the inm terminal is coupled to the C+ potential.

When a charger is coupled to the C+/C− ports, the voltage at the inm terminal of OP3 is pulled up, the voltage difference between inp and inm drops, the output voltage out of the operational amplifier circuit drops, driving MP1 to tend to turn on and pulling down the inm potential (i.e., the inm potential). At this time, a negative feedback control loop is formed, so that the Vds voltage drop across MP1 during charging is controllable. By appropriately adjusting the gain and input offset of OP3, adjustment of the Vds of MP1 during charging can be achieved.

When a load is coupled to the C+/C− ports, the voltage at the inm terminal of OP3 is pulled down, the voltage difference between inp and inm rises, the output voltage out of the operational amplifier circuit rises, driving MP1 to tend to be turned off, thereby making it easier for the load to pull down C+ (i.e., the inm potential). At this time, a positive feedback control loop is formed, so that when a load is coupled to C+/C−, MN1 can be stably in an off state that prohibits discharging. Similarly, by appropriately adjusting the gain and input offset of OP3, the tolerance of C+/C− for load current can be achieved, such as zero tolerance or limited tolerance.

When the protection circuit separates the charging port and the discharging port, and the charging positive terminal and the discharging positive terminal are independent of each other, while satisfying the requirement that the discharging port can only be used for discharging and cannot be used for charging, the corresponding protection circuit may be as shown in FIG. 9.

A PMOS transistor MP2 is added at the P+ terminal, with its drain coupled to C+, its bulk and source coupled to P+, and its gate driven by the output of an operational amplifier circuit OP4 (having the same function as the aforementioned operational amplifier circuit OP2).

For the operational amplifier circuit OP4, inp is a positive input terminal for a differential signal, inm is a negative input terminal for the differential signal, and the output out outputs an amplified voltage signal of the differential signal. The inp terminal of OP4 is coupled to the P+ potential, and the inm terminal is coupled to the C+ potential.

When a load is coupled to the P+/P− ports, the voltage at the inp terminal of OP4 is pulled down, the voltage difference between inp and inm drops, the output voltage out of the operational amplifier circuit drops, driving MN1 to tend to turn on and pulling up the P+ potential (i.e., the inp potential). At this time, a negative feedback control loop is formed, so that the Vds voltage drop across MP2 during discharging is controllable. By appropriately adjusting the gain and input offset of OP4, adjustment of the Vds of MP2 during discharging can be achieved.

When a charger is coupled to the P+/P− ports, the voltage at the inp terminal of OP4 is pulled up, the voltage difference between inp and inm rises, the output voltage out of the operational amplifier circuit rises, driving MP2 to tend to be turned off, thereby making it easier for the charger to pull up P+ (i.e., the inp potential). At this time, a positive feedback control loop is formed, so that when a charger is coupled to P+/P−, MP2 can be stably in an off state that prohibits charging. Similarly, by appropriately adjusting the gain and input offset of OP4, the tolerance of P+/P− for charging current can be achieved, such as zero tolerance or limited tolerance.

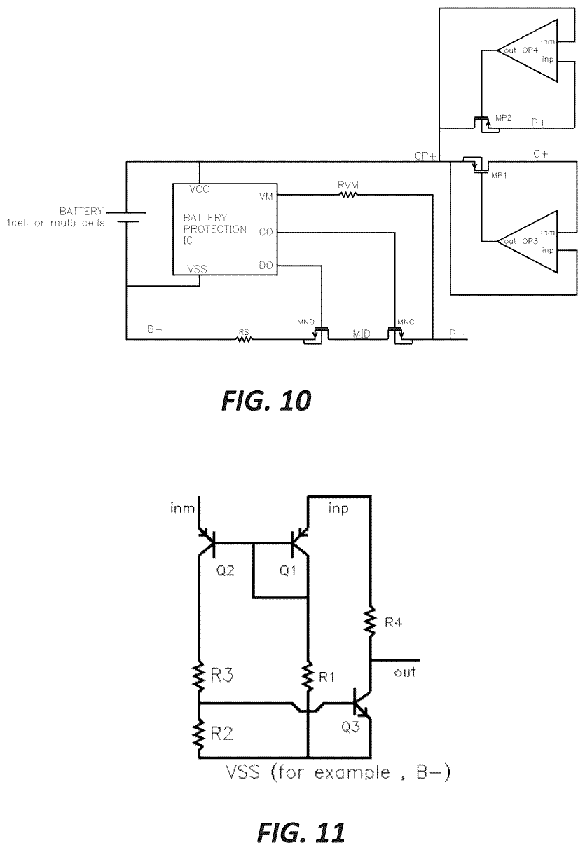

When the protection circuit separates the charging port and the discharging port, and the charging positive terminal and the discharging positive terminal are independent of each other, while satisfying the requirements that the discharging port can only be used for discharging and cannot be used for charging, and the charging port can only be used for charging and cannot be used for discharging, the corresponding protection circuit may be as shown in FIG. 10.

A PMOS transistor MP1 is added at the C+ terminal, with its drain coupled to C+, its bulk and source coupled to CP+, and its gate driven by the output of the operational amplifier circuit OP3.

For the operational amplifier circuit OP3, inp is a positive input terminal for a differential signal, inm is a negative input terminal for the differential signal, and the output out outputs an amplified voltage signal of the differential signal. The inp terminal of OP1 is coupled to CP+, and the inm terminal is coupled to the C+ potential.

When a charger is coupled to the C+/C− ports, the voltage at the inm terminal of OP3 is pulled up, the voltage difference between inp and inm drops, the output voltage out of the operational amplifier circuit drops, driving MP1 to tend to turn on and pulling down the inm potential (i.e., the inm potential). At this time, a negative feedback control loop is formed, so that the Vds voltage drop across MP1 during charging is controllable. By appropriately adjusting the gain and input offset of OP3, adjustment of the Vds of MP1 during charging can be achieved.

When a load is coupled to the C+/C− ports, the voltage at the inm terminal of OP3 is pulled down, the voltage difference between inp and inm rises, the output voltage out of the operational amplifier circuit rises, driving MP1 to tend to be turned off, thereby making it easier for the load to pull down C+ (i.e., the inm potential). At this time, a positive feedback control loop is formed, so that when a load is coupled to C+/C−, MN1 can be stably in an off state that prohibits discharging. Similarly, by appropriately adjusting the gain and input offset of OP3, the tolerance of C+/C− for load current can be achieved, such as zero tolerance or limited tolerance.

A PMOS transistor MP2 is added at the P+terminal, with its drain coupled to CP+, its bulk and source coupled to P+, and its gate driven by the output of the operational amplifier circuit OP4.

For the operational amplifier circuit OP4, inp is a positive input terminal for a differential signal, inm is a negative input terminal for the differential signal, and the output out outputs an amplified voltage signal of the differential signal. The inp terminal of OP4 is coupled to the P+ potential, and the inm terminal is coupled to the CP+ potential.

When a load is coupled to the P+/P− ports, the voltage at the inp terminal of OP4 is pulled down, the voltage difference between inp and inm drops, the output voltage out of the operational amplifier circuit drops, driving MN1 to tend to turn on and pulling up the P+ potential (i.e., the inp potential). At this time, a negative feedback control loop is formed, so that the Vds voltage drop across MP2 during discharging is controllable. By appropriately adjusting the gain and input offset of OP4, adjustment of the Vds of MP2 during discharging can be achieved.

When a charger is coupled to the P+/P− ports, the voltage at the inp terminal of OP4 is pulled up, the voltage difference between inp and inm rises, the output voltage out of the operational amplifier circuit rises, driving MP2 to tend to be turned off, thereby making it easier for the charger to pull up P+ (i.e., the inp potential). At this time, a positive feedback control loop is formed, so that when a charger is coupled to P+/P−, MP2 can be stably in an off state that prohibits charging. Similarly, by appropriately adjusting the gain and input offset of OP4, the tolerance of P+/P− for charging current can be achieved, such as zero tolerance or limited tolerance.

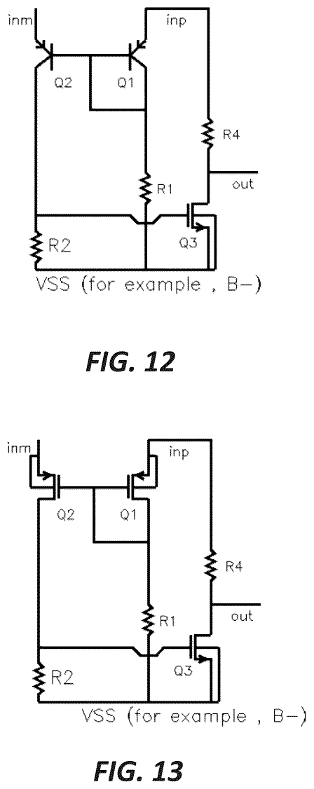

In the present invention, specific implementation methods of the operational amplifier circuits OP3 and OP4 can be seen in FIG. 11 to FIG. 13.

In FIG. 11 to FIG. 13, Q1 and Q2 are pnp bipolar transistors or PMOS transistors, Q3 is an npn bipolar transistor or an NMOS transistor, and R1, R2, R3, and R4 are resistors.

Wherein, R3 functions for current limiting and voltage division, and may be omitted if Q3 has sufficient voltage withstand capability or current carrying capacity.

The size ratio or the transistor types of Q1 and Q2 can be appropriately adjusted to achieve different input offsets. Transistors or resistors may also be coupled in series between the emitters or sources of Q1, Q2 and inp, inm to achieve different input offsets.

In one embodiment, the control circuit is integrated within the battery protection unit, that is, the operational amplifier is integrated within the battery protection unit, and the battery protection unit is an integrated circuit chip.

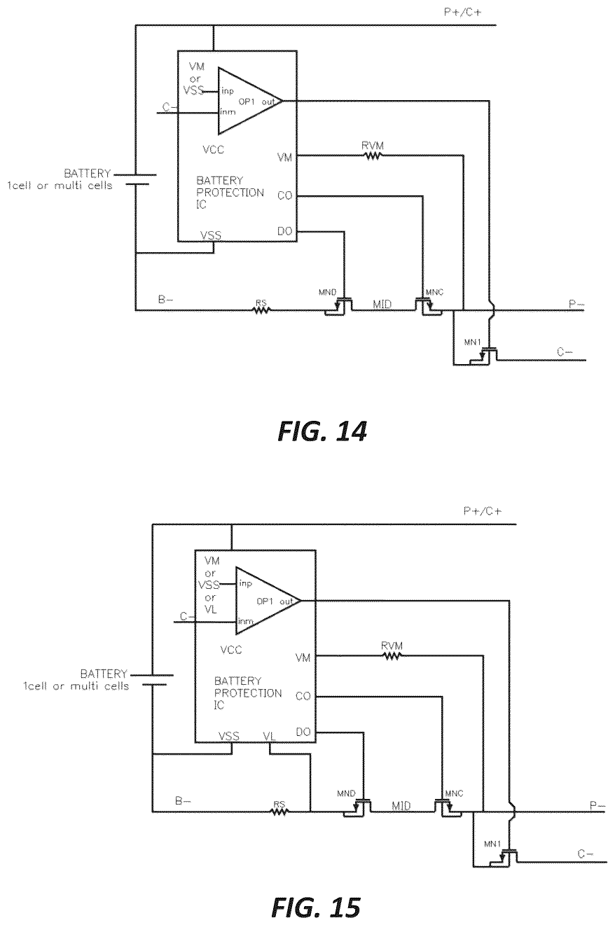

Exemplarily, after the aforementioned operational amplifier circuit OP1 is integrated within the chip, the protection circuit may be as shown in FIG. 14 or FIG. 15. The elements shown in FIG. 14 or FIG. 15 can also be understood with reference to the corresponding description of FIG. 2. It should be noted that the chip in FIG. 15 additionally comprises a detection pin VL port, and the VL port can also be coupled to the inp terminal of OP1.

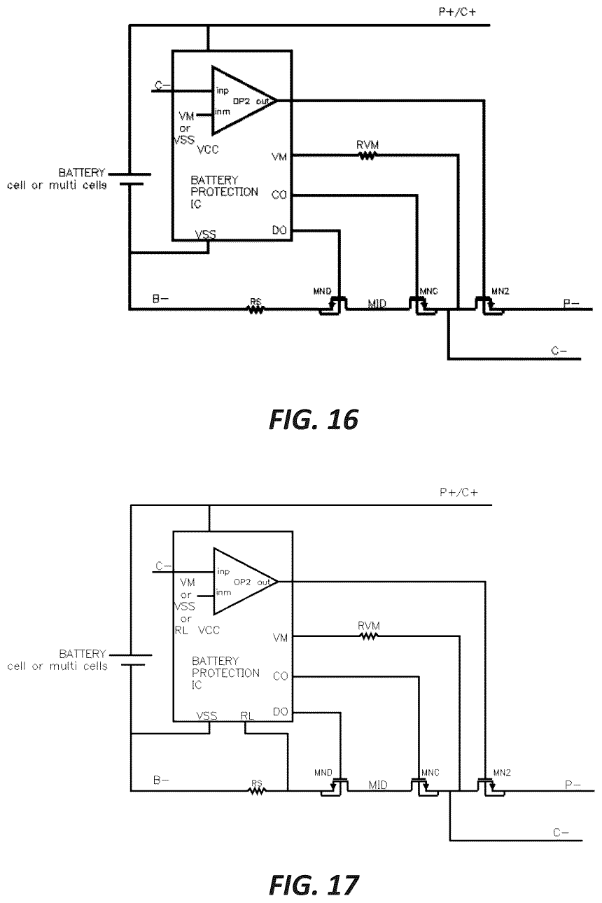

After the aforementioned operational amplifier circuit OP2 is integrated within the chip, the protection circuit may be as shown in FIG. 16 or FIG. 17. The elements shown in FIG. 16 or FIG. 17 can also be understood with reference to the corresponding description of FIG. 3. It should be noted that the chip in FIG. 17 additionally comprises a detection pin RL port, and the RL port can also be coupled to the inm terminal of OP2.

It is easily conceivable from FIG. 14 to FIG. 17 that by varying the circuit of FIG. 4, the control circuit OP1 of the unidirectional charging port switch MN1 and the control circuit OP2 of the unidirectional discharging port switch MN2 can be simultaneously integrated into the chip. To avoid repetition, details are not repeated here.

According to another embodiment of the present invention, a battery protection circuit is provided. The battery protection circuit comprises: a first charging port, a first discharging port, a second charging port, a second discharging port, a charge-discharge switch assembly, a battery protection unit, a battery, a shunt switch, and a control circuit electrically coupled to a control terminal of the shunt switch. The first charging port, the battery, the charge-discharge switch assembly, and the second charging port form a charging loop, and the first discharging port, the battery, the charge-discharge switch assembly, and the second discharging port form a discharging loop.

The shunt switch can be electrically coupled within the charging loop or/and the discharging loop.

When the shunt switch is electrically coupled within the charging loop, the control circuit is configured to: detect whether a device electrically coupled between the first charging port and the second charging port is a charger or a load, control the shunt switch to turn on when the charger is electrically coupled between the first charging port and the second charging port, and control the shunt switch to turn off when the load is electrically coupled between the first charging port and the second charging port.

When the shunt switch is electrically coupled within the discharging loop, the control circuit is configured to: detect whether a device electrically coupled between the first discharging port and the second discharging port is a charger or a load, and control the shunt switch to turn off when the charger is electrically coupled between the first discharging port and the second discharging port, and control the shunt switch to turn on when the load is electrically coupled between the first discharging port and the second discharging port.

The control circuit comprises an operational amplifier, and an output terminal of the operational amplifier is electrically coupled to the control terminal of the shunt switch.

In one embodiment, the shunt switch is electrically coupled to the second charging port, a first connection terminal of the operational amplifier is electrically coupled to the second charging port, and a second connection terminal of the operational amplifier is electrically coupled to a first internal node, the first internal node being a node between the second discharging port and the battery.

In another embodiment, the shunt switch is electrically coupled to the second discharging port, the first connection terminal of the operational amplifier is electrically coupled to the second discharging port, and the second connection terminal of the operational amplifier is electrically coupled to a second internal node, the second internal node being a node between the second charging port and the battery.

The shunt switch is a MOS transistor, one conductive connection terminal of the MOS transistor is electrically coupled to the battery, the other conductive connection terminal of the MOS transistor is electrically coupled to one of the second charging port and the first charging port or one of the second discharging port and the third discharging port, and a gate of the MOS transistor is electrically coupled to an output terminal of the control circuit.

In the present invention, terms such as “connect,” “coupled,” “couple,” and the like, which denote electrical connection, indicate direct or indirect electrical connection unless otherwise specified. The direct electrical connection refers to a direct connection between two or more objects without any intervening object, and the indirect electrical connection refers to a connection between two or more objects with one or more intervening objects (such as electrical elements or units like resistors, capacitors, inductors, switches, filters, etc.).

The terms “comprise,” “include,” or any other variants thereof in the embodiments of the present disclosure are intended to cover non-exclusive inclusion, so that a process, method, article, or device comprising a series of elements not only includes those elements, but also includes other elements not explicitly listed, or further includes elements inherent to such a process, method, article, or device. In the absence of further limitations, an element defined by the phrase “comprising a ...” does not preclude the presence of additional identical elements in the process, method, article, or device comprising said element.

The term “or” in the present disclosure denotes an inclusive “or,” rather than an exclusive “or.” Reference to a “first” component does not necessarily require provision of a “second” component. Furthermore, unless explicitly indicated, the terms “first” or “second” do not imply that the referenced component is limited to a specific order.

The embodiments of the present invention are described above in conjunction with the accompanying drawings, but the present invention is not limited to the specific embodiments described above, the specific embodiments described above are merely illustrative and not limiting, and the person of ordinary skill in the field of the present invention, without departing from the purpose of the application and the scope of protection of the claims, may also make many forms, all of which are under the protection of the present invention.

Although preferred embodiments of the present invention have been described, additional changes and modifications to these embodiments may be made once the basic creative concepts are known to those skilled in the art. The appended claims are therefore intended to be interpreted to comprise preferred embodiments and all changes and modifications falling within the scope of the present invention.

Obviously, a person skilled in the art may make various changes and variations to the application without departing from the spirit and scope of the application. Thus, if these modifications and variations of the present invention fall within the scope of the claims and their equivalent technologies, the application is also intended to comprise these changes and variations.

What is claimed is:

1. A battery protection circuit, comprising:
a first charging port, a first discharging port, a second charging port, a second discharging port, a charge-discharge switch assembly, a battery protection unit, a battery, a shunt switch, and a control circuit electrically coupled to a control terminal of the shunt switch;
wherein the first charging port, the battery, the charge-discharge switch assembly, and the second charging port form a charging loop, and the first discharging port, the battery, the charge-discharge switch assembly, and the second discharging port form a discharging loop;
wherein when the shunt switch is electrically coupled between the charge-discharge switch assembly and the second charging port, the control circuit is configured to: detect whether a device electrically coupled between the first charging port and the second charging port is a charger or a load, control the shunt switch to turn on when the charger is electrically coupled between the first charging port and the second charging port, and control the shunt switch to turn off when the load is electrically coupled between the first charging port and the second charging port;
wherein when the shunt switch is electrically coupled between the charge-discharge switch assembly and the second discharging port, the control circuit is configured to: detect whether a device electrically coupled between the first discharging port and the second discharging port is the charger or the load, and control the shunt switch to turn off when the charger is electrically coupled between the first discharging port and the second discharging port, and control the shunt switch to turn on when the load is electrically coupled between the first discharging port and the second discharging port.

2. The battery protection circuit according to claim 1, wherein the first charging port, the first discharging port, and a first power supply terminal of the battery protection unit are all electrically coupled to a positive electrode or a negative electrode of the battery; a second power supply terminal of the battery protection unit and a first conductive connection terminal of the charge-discharge switch assembly are both electrically coupled to the negative electrode or the positive electrode of the battery; an output terminal of the battery protection unit is electrically coupled to a control terminal of the charge-discharge switch assembly; and the second charging port and the second discharging port are both electrically coupled to a second conductive connection terminal of the charge-discharge switch assembly;
the shunt switch is a MOS transistor, one conductive connection terminal of the MOS transistor is electrically coupled to the charge-discharge switch assembly, the other conductive connection terminal of the MOS transistor is electrically coupled to the second charging port or the second discharging port, and a gate of the MOS transistor is electrically coupled to an output terminal of the control circuit.

3. The battery protection circuit according to claim 1, wherein the control circuit comprises an operational amplifier, and an output terminal of the operational amplifier is electrically coupled to the control terminal of the shunt switch;
a first connection terminal of the operational amplifier is electrically coupled to the second charging port, and a second connection terminal of the operational amplifier is electrically coupled to a first internal node, the first internal node being a node between the second discharging port and the negative electrode of the battery; or,
the first connection terminal of the operational amplifier is electrically coupled to the second discharging port, and the second connection terminal of the operational amplifier is electrically coupled to a second internal node, the second internal node being a node between the second charging port and the negative electrode of the battery.

4. The battery protection circuit according to claim 3, wherein the operational amplifier is configured to: amplify a difference between a voltage at the first connection terminal and a voltage received at the second connection terminal, and output an amplified difference to the control terminal of the shunt switch.

5. The battery protection circuit according to claim 4, wherein the operational amplifier comprises: a first bipolar transistor, a second bipolar transistor, and a third bipolar transistor;
wherein a base of the first bipolar transistor and a base of the second bipolar transistor are both electrically coupled to an emitter of the third bipolar transistor; a collector of the first bipolar transistor is electrically coupled to the emitter of the third bipolar transistor; a collector of the third bipolar transistor is electrically coupled to an emitter of the first bipolar transistor; a collector of the second bipolar transistor is electrically coupled to the emitter of the third bipolar transistor; and a base of the third bipolar transistor is electrically coupled to the collector of the second bipolar transistor;
the first connection terminal is a terminal at the emitter of the first bipolar transistor, the second connection terminal is a terminal at an emitter of the second bipolar transistor, and the output terminal of the operational amplifier is a terminal at the collector of the third bipolar transistor.

6. The battery protection circuit according to claim 5, wherein a first resistor is coupled in series between the base of the first bipolar transistor and the emitter of the third bipolar transistor; a second resistor is coupled in series between the base of the third transistor and the emitter of the third bipolar transistor; and a fourth resistor is coupled in series between the collector of the third bipolar transistor and the emitter of the first bipolar transistor.

7. The battery protection circuit according to claim 6, wherein a third resistor is coupled in series between the collector of the second bipolar transistor and the base of the third bipolar transistor.

8. The battery protection circuit according to claim 6, wherein one or all of the first, second, and third bipolar transistors can be replaced with MOS transistors, wherein the base, collector, and emitter of the bipolar transistor correspond to the gate, drain, and source of the respective MOS transistor, respectively.

9. The battery protection circuit according to claim 1, wherein the control circuit is integrated within the battery protection unit, and the battery protection unit is an integrated circuit chip.

10. The battery protection circuit according to claim 1, wherein the first charging port and the first discharging port are a shared first charge-discharge port or two mutually independent ports, and the second charging port and the second discharging port are two mutually independent ports.

11. The battery protection circuit according to claim 10, wherein the first charging port is a C+ charging port, the second charging port is a C− charging port, the first discharging port is a P+ discharging port, and the second discharging port is a P− discharging port; or,
the first charging port is a C− charging port, the second charging port is a C+ charging port, the first discharging port is a P− discharging port, and the second discharging port is a P+ discharging port.

12. The battery protection circuit according to claim 10, wherein the charge-discharge switch assembly comprises a charging switch and a discharging switch coupled in series, and the output terminal of the battery protection unit comprises a first control output terminal and a second control output terminal; the first control output terminal of the battery protection unit is coupled to a control terminal of the charging switch, and the second control output terminal of the battery protection unit is coupled to a control terminal of the discharging switch.

13. A battery protection circuit, comprising:
a first charging port, a first discharging port, a second charging port, a second discharging port, a charge-discharge switch assembly, a battery protection unit, a battery, a shunt switch, and a control circuit electrically coupled to a control terminal of the shunt switch;
wherein the first charging port, the battery, the charge-discharge switch assembly, and the second charging port form a charging loop, and the first discharging port, the battery, the charge-discharge switch assembly, and the second discharging port form a discharging loop;
wherein when the shunt switch is electrically coupled within the charging loop, the control circuit is configured to: detect whether a device electrically coupled between the first charging port and the second charging port is a charger or a load, control the shunt switch to turn on when the charger is electrically coupled between the first charging port and the second charging port, and control the shunt switch to turn off when the load is electrically coupled between the first charging port and the second charging port;
wherein when the shunt switch is electrically coupled within the discharging loop, the control circuit is configured to: detect whether a device electrically coupled between the first discharging port and the second discharging port is the charger or the load, and control the shunt switch to turn off when the charger is electrically coupled between the first discharging port and the second discharging port, and control the shunt switch to turn on when the load is electrically coupled between the first discharging port and the second discharging port.

14. The battery protection circuit according to claim 13, wherein the control circuit comprises an operational amplifier, and an output terminal of the operational amplifier is electrically coupled to the control terminal of the shunt switch;
the shunt switch is electrically coupled to the second charging port, a first connection terminal of the operational amplifier is electrically coupled to the second charging port, and a second connection terminal of the operational amplifier is electrically coupled to a first internal node, the first internal node being a node between the second discharging port and the battery; or,
the shunt switch is electrically coupled to the second discharging port, the first connection terminal of the operational amplifier is electrically coupled to the second discharging port, and the second connection terminal of the operational amplifier is electrically coupled to a second internal node, the second internal node being a node between the second charging port and the battery.

15. The battery protection circuit according to claim 14, wherein the operational amplifier is configured to: amplify a difference between a voltage at the first connection terminal and a voltage received at the second connection terminal, and output an amplified difference to the control terminal of the shunt switch.

16. The battery protection circuit according to claim 13, wherein the control circuit is integrated within the battery protection unit, and the battery protection unit is an integrated circuit chip.

17. The battery protection circuit according to claim 13, wherein the first charging port and the first discharging port are a shared first charge-discharge port or two mutually independent ports, and the second charging port and the second discharging port are two mutually independent ports.

18. The battery protection circuit according to claim 17, wherein the first charging port is a C+ charging port, the second charging port is a C− charging port, the first discharging port is a P+discharging port, and the second discharging port is a P− discharging port; or,
the first charging port is a C− charging port, the second charging port is a C+ charging port, the first discharging port is a P− discharging port, and the second discharging port is a P+ discharging port.

19. The battery protection circuit according to claim 13, wherein the shunt switch is a MOS transistor, one conductive connection terminal of the MOS transistor is electrically coupled to the battery, the other conductive connection terminal of the MOS transistor is electrically coupled to one of the second charging port and the first charging port or one of the second discharging port and the third discharging port, and a gate of the MOS transistor is electrically coupled to an output terminal of the control circuit.

20. A battery protection circuit, comprising:
a first charging port, a first discharging port, a second charging port, a second discharging port, a charge-discharge switch assembly, a battery protection unit, a shunt switch, and a control circuit electrically coupled to a control terminal of the shunt switch;
wherein the first charging port, a battery, the charge-discharge switch assembly, and the second charging port form a charging loop, and the first discharging port, the battery, the charge-discharge switch assembly, and the second discharging port form a discharging loop;
wherein when the shunt switch is electrically coupled within the charging loop, the control circuit is configured to: detect whether a device electrically coupled between the first charging port and the second charging port is a charger or a load, control the shunt switch to turn on when the charger is electrically coupled between the first charging port and the second charging port, and control the shunt switch to turn off when the load is electrically coupled between the first charging port and the second charging port;
wherein when the shunt switch is electrically coupled within the discharging loop, the control circuit is configured to: detect whether a device electrically coupled between the first discharging port and the second discharging port is a charger or a load, and control the shunt switch to turn off when the charger is electrically coupled between the first discharging port and the second discharging port, and control the shunt switch to turn on when the load is electrically coupled between the first discharging port and the second discharging port.
